(19) United States
(12) Patent Application Publication
(10) Pub. No.: US 2009/0100152 A1
(43) Pub. Date: Apr. 16, 2009

(54) SYSTEM FOR SELECTING A NETWORK ELEMENT

(75) Inventors: Armstrong Soo, San Ramon, CA (US); Bernard Ku, Austin, TX (US); Alexander L. Huang, Austin, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/870,892

(22) Filed: Oct. 11, 2007

(51) Int. Cl. G06F 15/16

(52) U.S. Cl. 709/219

(57) ABSTRACT

A system that incorporates teachings of the present disclosure may include, for example, a client terminal having a controller to transmit a request for a communication identifier of each of a plurality of network elements in a proximity to the client terminal, receive the communication identifier of each of the plurality of network elements, initiate a quality assurance test with a quality assurance client of each of the plurality of network elements according to the communication identifier of the respective network element, compare telemetry information derived from the quality assurance test for each of the plurality of network elements to a desired operational criterion, select one of the plurality of network elements according to said comparison, and consume one or more services provided by the selected network element. Other embodiments are disclosed.

### FIELD OF THE DISCLOSURE

The present disclosure relates generally to communication services and more specifically to a system for selecting a network element.

### BACKGROUND

It is common today for service providers of telecommunication networks to offer time-sensitive content by over engineering a network to compensate for anomalous network traffic. Redundant networks are typically designed in clusters of network elements in dispersed locations. Service providers program a number of network elements to distribute loads statistically or under the direction of a load balancer that attempts to distribute network traffic evenly between network elements in a round-robin fashion for example.

Typically load balancing can occur without regards to a proximity between a network element (e.g., router or switch) and a client terminal (e.g., computer, cell phone, landline phone, etc.). Load balancing techniques may therefore result in a situation in which a client terminal is assigned to a network element that exceeds a maximum network delay that can adversely affect services. Other suboptimal service issues may arise due to the ad hoc nature of present network topologies and traffic management techniques.

### BRIEF DESCRIPTION OF THE DRAWINGS

FIGS. 1-2 depict exemplary embodiments of a communication system;

FIGS. 3-6 depict exemplary methods and corresponding exemplary block diagrams operating in portions of the communication system; and

FIG. 7 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium operating in a Quality Assurance System (QAS) of a communication system can have computer instructions for receiving from an Address Resolution System (ARS) a first Internet Protocol (IP) address of a client terminal requesting a service of the communication system, identifying a plurality of network elements of the communication system able to supply the client terminal the requested service, transmitting the first IP address of the client terminal to the plurality of network elements, receiving from each of the plurality of network elements one or more test results generated from a quality assurance test conducted between each of the plurality of network elements and the client terminal, selecting one of the plurality of network elements to provide the requested service according to the one or more test results supplied by the plurality of network elements, and transmitting to the ARS a second IP address of the selected network element.

In one embodiment of the present disclosure, a client terminal can have a controller to transmit a request for a communication identifier of each of a plurality of network elements in a proximity to the client terminal, receive the communication identifier of each of the plurality of network elements, initiate a quality assurance test with a quality assurance client of each of the plurality of network elements according to the communication identifier of the respective network element, compare telemetry information derived from the quality assurance test for each of the plurality of network elements to a desired operational criterion, select one of the plurality of network elements according to said comparison, and consume one or more services provided by the selected network element.

In one embodiment of the present disclosure, a client terminal can have a controller to transmit a request for network services, receive one or more test packets from each of a plurality of network elements, transmit telemetry information to each of the plurality of network elements according to the one or more test packets received, receive a communication identifier of a select one of the plurality of network elements selected according to its telemetry information, and consume one or more services provided by the selected network element.

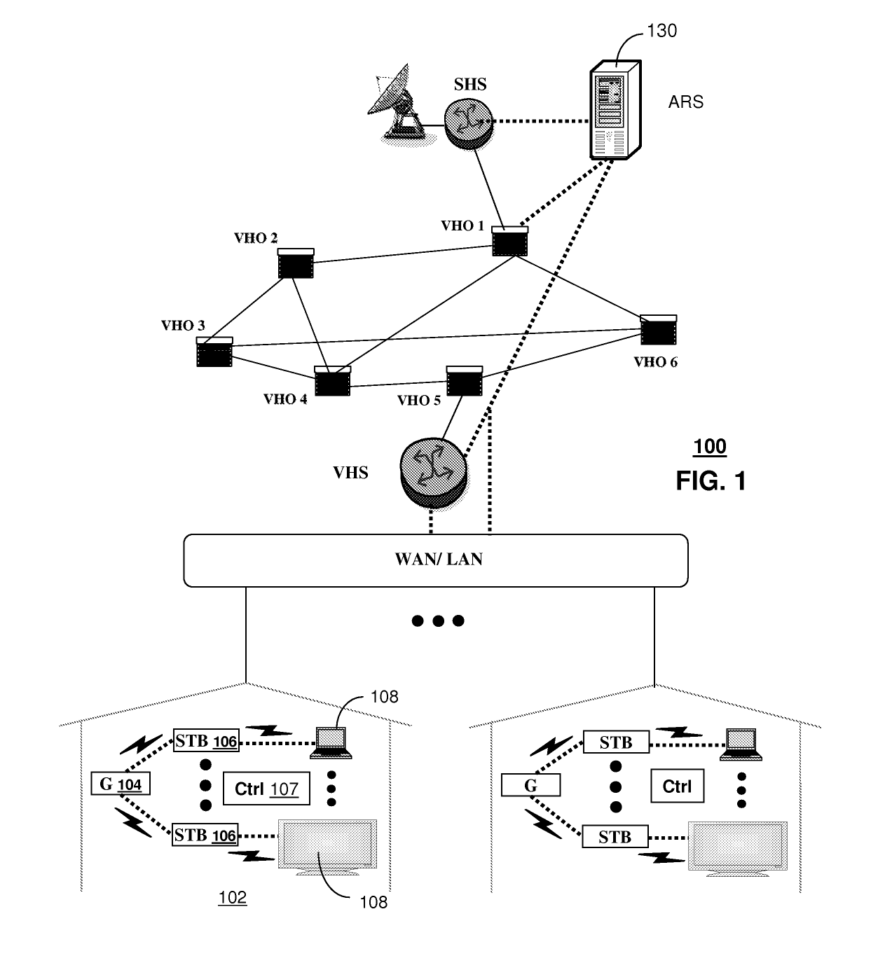

FIG. 1 depicts an exemplary embodiment of a communication system 100 employing an IPTV broadcast media architecture. In a typical IPTV infrastructure, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS can be located in a central office.

From the central office, the VHS can distribute multimedia broadcast programs to commercial and/or residential buildings 102 housing a gateway 104 (e.g., a residential gateway or RG) by way of wide area or local area networks utilizing fiber or twisted pair cables. The gateway 104 distributes broadcast signals to media receivers 106 such as Set-Top Boxes (STBs) which in turn present broadcast selections to media devices 108 such as computers or television sets managed in some instances by a media controller 107 (e.g., an infrared or RF remote control). Unicast traffic can also be exchanged between the media receivers 106 and subsystems of the IPTV media system 100 for services such as video-on-demand (VoD).

An address resolution system (ARS) 130 utilizing common computing and communication technologies can be coupled to one or more of the sub-network elements of the IPTV system to manage the assignment of the sub-network elements to client devices such as gateway 104 and/or STBs 106.

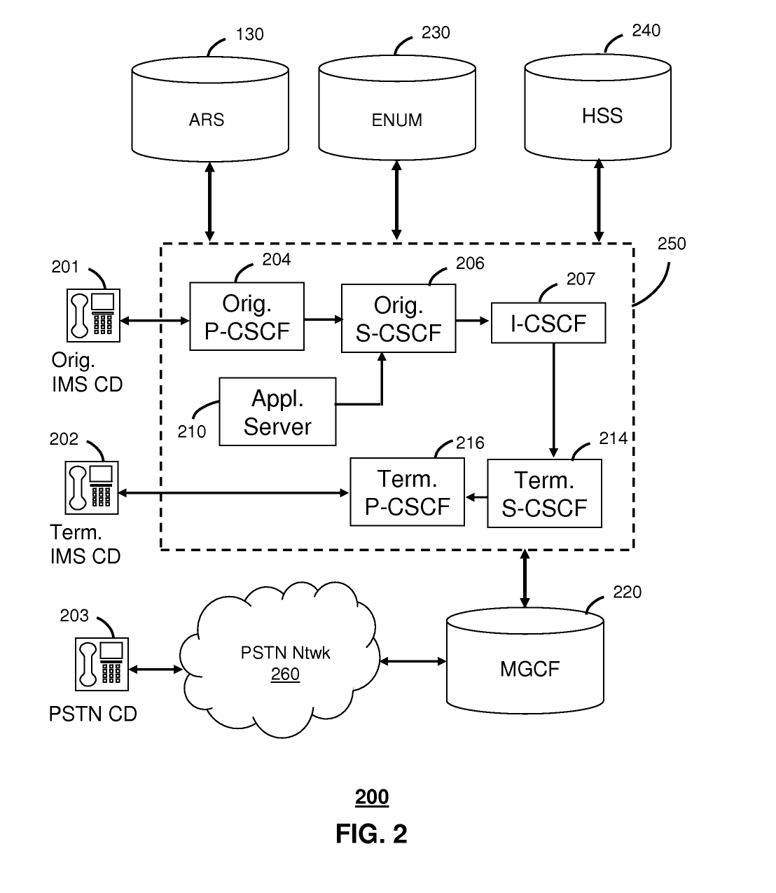

FIG. 2 depicts an exemplary embodiment of a communication system 200 employing an IP Multimedia Subsystem (IMS) network architecture depicted as a high level block diagram. Communication system 200 can be overlaid or operably coupled with communication system 100 as another representative embodiment of communication system 100.

The communication 200 can comprise a Home Subscriber Server (HSS) 240, a tElephone NUmber Mapping (ENUM) server 230, and network elements of an IMS network 250. The IMS network 250 can be coupled to IMS compliant communication devices (CD) 201, 202 or a Public Switched Telephone Network (PSTN) CD 203 using a Media Gateway Control Function (MGCF) 220 that connects the call through a common PSTN network 260.

IMS CDs 201, 202 register with the IMS network 250 by contacting a Proxy Call Session Control Function (P-CSCF) which communicates with a corresponding Serving CSCF (S-CSCF) to register the CDs with an Authentication, Authorization and Accounting (AAA) support by the HSS 240. To accomplish a communication session between CDs, an originating IMS CD 201 can submit a SIP INVITE message to an originating P-CSCF 204 which communicates with a corresponding originating S-CSCF 206. The originating S-CSCF 206 can submit the SIP INVITE message to an application server (AS) such as reference 210 that can provide a variety of services to IMS subscribers. For example, the application server 115 can be used to perform originating treatment functions on the calling party number received by the originating S-CSCF 206 in the SIP INVITE message. Originating treatment functions can include determining whether the calling party number has international calling services, and/or is requesting special telephony features (e.g., *72 forward calls, *73 cancel call forwarding, *67 for caller ID blocking, and so on).

Additionally, the originating SCSCF 206 can submit queries to the ENUM system 230 to translate an E.164 telephone number to a SIP Uniform Resource Identifier (URI) if the targeted communication device is IMS compliant. If the targeted communication device is a PSTN device, the ENUM system 230 will respond with an unsuccessful address resolution and the S-CSCF 206 will forward the call to the MGCF 220 via a Breakout Gateway Control Function (not shown).

When the ENUM server 230 returns a SIP URI, the SIP URI is used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214 which can call on an application server similar to reference 210 to perform the originating treatment telephony functions described earlier. The terminating S-CSCF 214 can then identify a terminating P-CSCF 216 associated with the terminating CD 202. The P-CSCF 216 then signals the CD 202 to establish communications. The aforementioned process is symmetrical. Accordingly, the terms “originating” and “terminating” in FIG. 2 can be interchanged.

The IMS network 250 can also be coupled to the ARS 130 for purposes of assigning network elements of the IMS network 250 to client terminals of for example a law enforcement agency (LEA) acting under the Communications Assistance for Law Enforcement Act (CALEA).

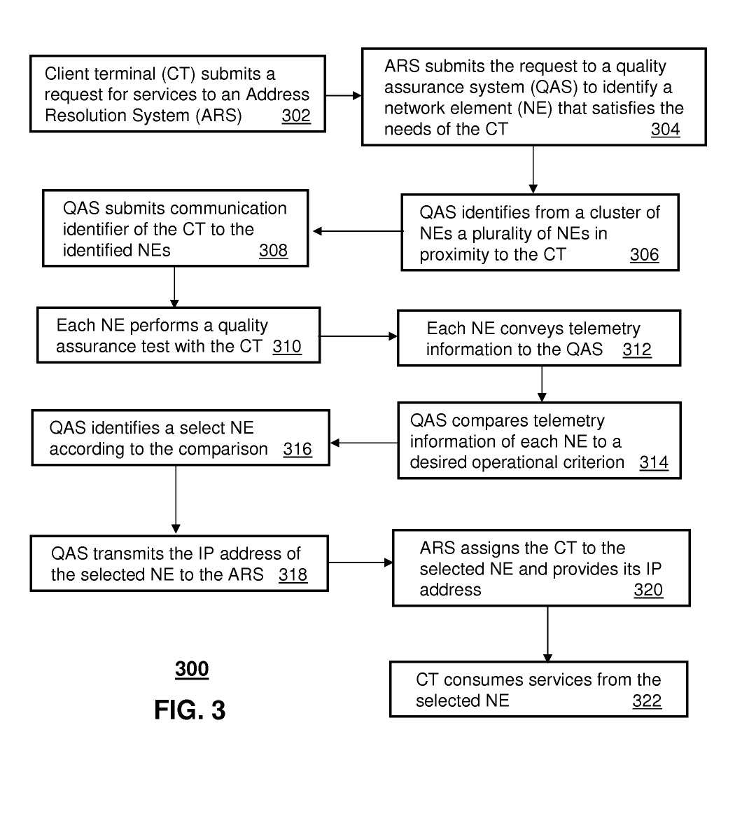

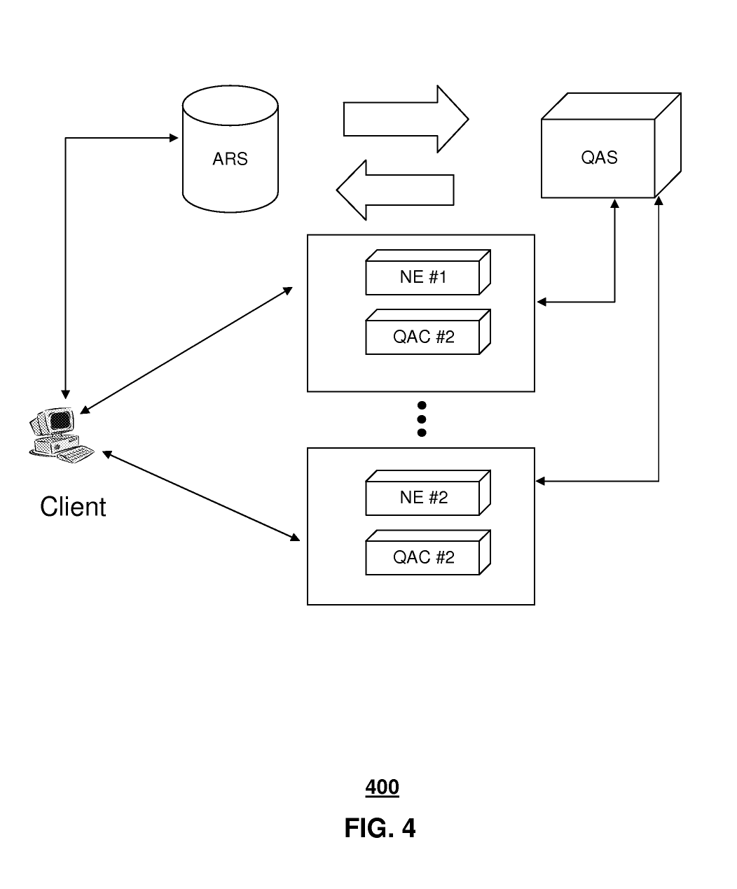

FIG. 3 depicts an exemplary method 300 operating in portions of the communication systems 100-200. FIG. 4 depicts an exemplary block diagram 400 that illustrates method 300. Method 300 begins with step 302 in which a client terminal such as for example a service area interface (SAI) in a residential or commercial area with active computing technology, a digital subscriber line access multiplexer (DSLAM) in a central office, an IMS CD 201, gateway 104 or STB 106, computer 108, cell phone, landline phone, or other suitable form of a communication device submits a request for services to the ARS 130. The request can among other things include information that identifies the communication services requested by the client terminal, a desired operation criterion, and a communication identifier that identifies the client terminal. The communication identifier can be a calling party number (e.g., an E.164 number), a SIP URI, and/or an Internet Protocol (IP) address.

In step 304 the ARS 130 can submit in whole or in part the request of the client terminal to a quality assurance system (QAS) which can operate as a sub-function of the ARS 130 or an independent system coupled to the ARS. The QAS can in step 306 identify from a cluster of network elements (NEs) of communication systems 100 or 200 a plurality of NEs in proximity to the client terminal. In the present context an NE that is in proximity to the client terminal can mean that said devices are in geographic proximity to each other or are located in a logical area (e.g., same local access and transport area or LATA). Thus the term proximity can have any suitable meaning that can be used to accomplish the goals of method 300. With for example a static IP address of the client terminal (if one were assigned thereto), the QAS can determine a location of the client terminal and which NEs are in its proximity that can provide the communication services requested. Proximity information can be maintained in a local database of the QAS or in a database managed by communication systems 100 and 200 which can be accessed by the QAS.

In step 308, the QAS can submit the communication identifier of the client terminal to the identified plurality of NEs and direct said NEs to perform a quality assurance test. A quality assurance client (QAC) of each NE can then perform a quality assurance test with the client terminal in step 310. The quality assurance test can take place by establishing temporary communications between each NE and the client terminal, followed by the transmission of test packets from either the NE, the client terminal or both. The test packets can be of any format and quantity that is sufficient to perform quality analysis on communication links coupling the NEs to the client terminal. This form of testing can be used to generate telemetry information that identifies for example transmission latency from either end of communications, and any detectable distortion (e.g., packet loss, packet sequence gaps, bit error rate, jitter, etc.).

In step 312, each NE can convey to the QAS telemetry information collected by the QAC of said NE. In step 314, the QAS can compare the telemetry information of each NE to a desired operational criterion. The operational criterion can be defined by the service provider of communication systems 100 and 200, and/or can be supplied by the client terminal as described earlier in step 302. The desired operation criterion can be for example one or more Quality of Service (QoS) metrics which achieve a desired quality of communication. Achieving QoS objectives can be useful in real-time applications such as Voice over IP (VoIP), streaming video, or audio.

The QAS can analyze the telemetry information supplied by each NE and determine in step 316 whether one or more NEs satisfy the QoS objectives of the service provider, the client terminal or both. If there is more than one NE that satisfies the objectives established by the service provider and/or the client terminal, the QAS can select the NE having the most promising telemetry information that suits the needs of the client terminal, or the QAS can select an NE based on load balancing considerations. In step 318, the QAS can then transmit the IP address (or other suitable communication identifier such as a SIP URI) of the select NE to the ARS 130 which can then assign it to the client terminal in step 320. From this point, the client terminal consumes in step 322 the service requested by way of establishing communications with the selected NE.

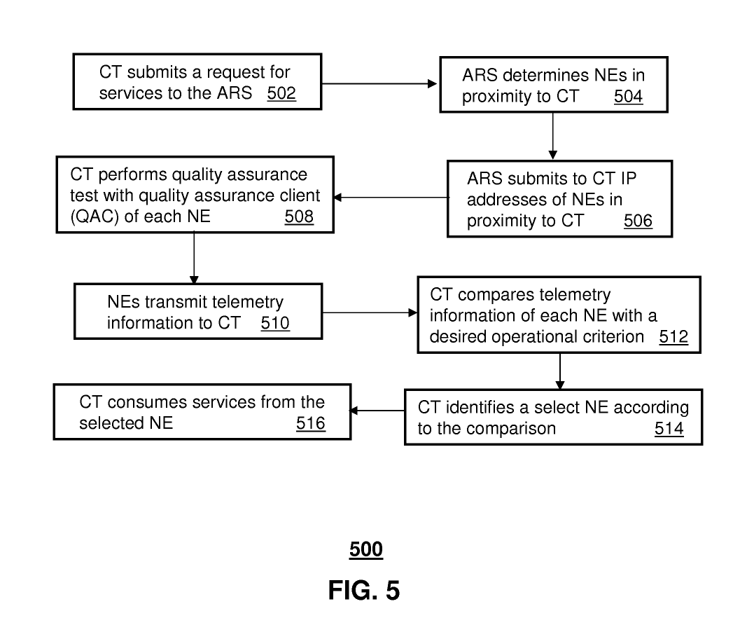

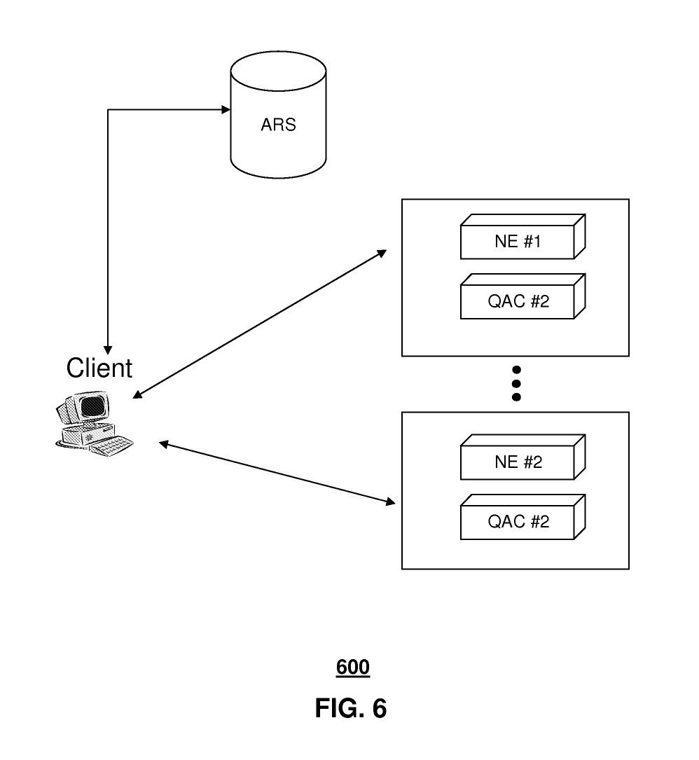

FIG. 5 depicts yet another exemplary method 500 that can operate in portions of the communication systems 100-200. FIG. 6 depicts an exemplary block diagram 600 that illustrates method 500. Method 500 begins with step 502 in which a client terminal submits a request to the ARS 130. The request can include similar information as described earlier for step 302 of FIG. 3. The ARS 130 in step 504 can determine which NEs are in proximity to the client terminal using the technique described earlier for method 300. In step 306, the ARS 130 can submit to the client terminal the IP addresses (or other suitable communication identifiers) of the NEs identified as being in a proximity to the client terminal.

The client terminal in step 508 can then perform a quality assurance test with the QAC of each NE. The quality assurance test can be conducted by transmitting test packets from the client terminal to the QAC and receiving therefrom telemetry information, and/or receiving at the client terminal test packets from the QAC and generating telemetry information therefrom. In step 512, the client terminal can then compare the telemetry information it has collected to a desired operation criterion and identify a select NE in manner similar to what was described in method 300. Once the selection has been made, the client terminal can begin to consume services in step 516 from the selected NE.

Methods 300 and 500 can have many applications. For example, said methods can be applied in CALEA applications where law enforcement has requested access to a targeted communication. In this instance, a client terminal can represent a computer or other suitable of equipment used by law enforcement which is making a request to access communication activity between two or more parties. Methods 300 and 500 can be employed to select a suitable Lawful Intercept Function (LIF) node and Media Resource Function (MRF) node combination of the IMS network of FIG. 2 (not shown) to link to an S-CSCF supplying communication services between parties to be monitored. In an IPTV application, methods 300 and 500 can be employed to identify a VHS that can best serve a gateway 104 and/or STBs 106 in its network.

Upon reviewing the aforementioned embodiments, it would be evident to an artisan with ordinary skill in the art that said embodiments can be modified, reduced, or enhanced without departing from the scope and spirit of the claims described below. For example, method 300 can be adapted so that the ARS 130 performs the functions of the QAS. Additionally, the QAS, ARS or the client terminal can compare the telemetry information to historical results from previous communications with NEs to select an NE. Moreover, methods 300 and 500 can be applied selectively between nodes in a proposed communication path to select optimal NEs for improving the quality of end-to-end communications.

These are but a few examples of modifications that can be applied to the present disclosure without departing from the scope of the claims. Accordingly, the reader is directed to the claims section for a fuller understanding of the breadth and scope of the present disclosure.

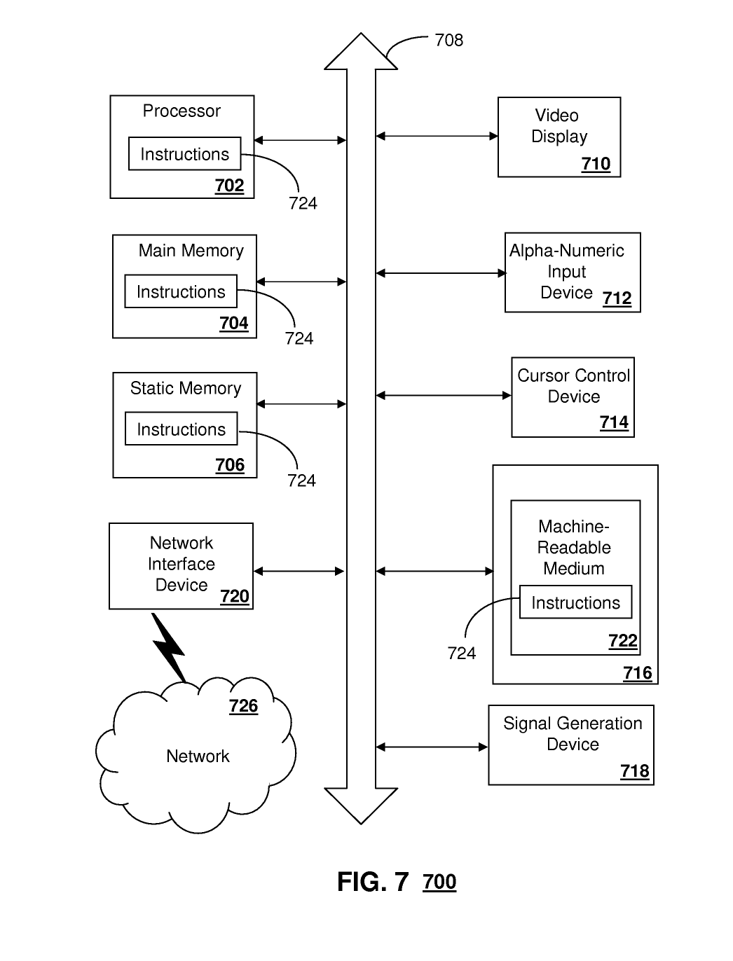

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium operating in a Quality Assurance System (QAS) of a communication system, comprising computer instructions for:
receiving from an Address Resolution System (ARS) a first Internet Protocol (IP) address of a client terminal requesting a service of the communication system;
identifying a plurality of network elements of the communication system able to supply the client terminal the requested service;
transmitting the first IP address of the client terminal to the plurality of network elements;
receiving from each of the plurality of network elements one or more test results generated from a quality assurance test conducted between each of the plurality of network elements and the client terminal;
selecting one of the plurality of network elements to provide the requested service according to the one or more test results supplied by the plurality of network elements; and
transmitting to the ARS a second IP address of the selected network element.

2. The storage medium of claim 1, wherein the ARS transmits the second IP address to the client terminal, and wherein the client terminal utilizes the second IP address to consume the requested service.

3. The storage medium of claim 1, wherein the plurality of network elements transmit test packets to the client terminal to perform the quality assurance test.

4. The storage medium of claim 3, wherein the client terminal generates telemetry information according to the test packets received in whole or in part by the client terminal.

5. The storage medium of claim 4, wherein the client terminal transmits the telemetry information to each of the plurality of network elements, and wherein the telemetry information comprises at least one among a transmission latency metric, and one or more metrics associated with detectable distortions.

6. The storage medium of claim 5, wherein each of the plurality of network elements transmits its telemetry information to the QAS as the one or more test results.

7. The storage medium of claim 1, wherein the client terminal transmits one or more test packets to each of the plurality of network elements to perform the quality assurance test.

8. The storage medium of claim 7, wherein each of the plurality of network elements generates telemetry information according to the one or more test packets received in whole or in part from the client terminal, and wherein the plurality of network elements transmit to the QAS its telemetry information as the one or more test results.

9. The storage medium of claim 8, wherein the telemetry information comprises at least one among a transmission latency metric, and one or more metrics associated with detectable distortions.

10. The storage medium of claim 1, comprising computer instructions for determining the selected one of the network elements according to a comparison of a desired criterion of operation and the one or more test results.

11. The storage medium of claim 1, comprising computer instructions for submitting a request to at least one cluster of network elements in the communication system to identify the plurality of network elements able to supply the client terminal the requested service and having a proximity to the client terminal.

12. The storage medium of claim 1, wherein the client terminal comprises one among a computer, a landline phone, and a mobile phone, and wherein the plurality of network elements operate in one among an IP Television (IPTV) communication system, and an IP Multimedia Subsystem (IMS) communication system.

13. A client terminal, comprising a controller to:
transmit a request for a communication identifier of each of a plurality of network elements in a proximity to the client terminal;
receive the communication identifier of each of the plurality of network elements;
initiate a quality assurance test with a quality assurance client of each of the plurality of network elements according to the communication identifier of the respective network element;
compare telemetry information derived from the quality assurance test for each of the plurality of network elements to a desired operational criterion;
select one of the plurality of network elements according to said comparison; and
consume one or more services provided by the selected network element.

14. The client terminal of claim 13, wherein the controller is adapted to transmit the request to an Address Resolution System (ARS), wherein the request includes a communication identifier comprising at least one among an Internet Protocol (IP) address of the client terminal, a calling party number of the client terminal, and a Session Initiation Protocol Uniform Resource Identifier of the client terminal.

15. The client terminal of claim 14, wherein the ARS determines the plurality of network elements in the proximity to the client terminal.

16. The client terminal of claim 13, wherein the controller is adapted to receive test packets from the quality assurance client of each of the plurality of network elements to perform the quality assurance test.

17. The client terminal of claim 16, wherein the controller is adapted to generate the telemetry information according to the test packets received in whole or in part.

18. The client terminal of claim 13, wherein the telemetry information comprises at least one among a transmission latency metric, and one or more metrics associated with detectable distortions.

19. The client terminal of claim 13, wherein the controller is adapted to:
transmit one or more test packets to the quality assurance client of each of the plurality of network elements to perform the quality assurance test; and
receive the telemetry information collectively from each of the quality assurance clients.

20. The client terminal of claim 13, wherein the desired operation criterion corresponds to one or more metrics associated with a desired Quality of Service, wherein the client terminal comprises one among a computer, a landline phone, and a mobile phone, and wherein the plurality of network elements operate in one among an IP Television (IPTV) communication system, and an IP Multimedia Subsystem (IMS) communication system.

21. A client terminal, comprising a controller to:
transmit a request for network services;
receive one or more test packets from each of a plurality of network elements;
transmit telemetry information to each of the plurality of network elements according to the one or more test packets received;
receive a communication identifier of a select one of the plurality of network elements selected according to its telemetry information; and
consume one or more services provided by the selected network element.

22. The client terminal of claim 21, wherein the communication identifier comprises an Internet Protocol (IP) address of the selected network element.

23. The client terminal of claim 21, wherein the controller is adapted to transmit to an Address Resolution System (ARS) the request with an IP address of the client terminal.

24. The client terminal of claim 23, wherein the ARS compares the telemetry information it received from each of the plurality of network elements to an operational criterion, identifies the selected network element from said comparison, and retrieves the communication identifier of the selected network element, and wherein the controller is adapted to receive the communication identifier from the ARS.
